(19) United States
(12) Patent Application Publication
(10) Pub. No.: US 2013/0124369 A1
(43) Pub. Date: May 16, 2013

(54) METHOD FOR ASSISTING PURCHASE, DEVICE AND SYSTEM

(71) Applicant: Katsuhisa Furuichi, Chiyoda-ku (JP)

(72) Inventor: Katsuhisa Furuichi, Chiyoda-ku (JP)

(73) Assignee: PURCHASING STRATEGY INSTITUTE CORPORATION, Chiyoda-ku, Tokyo (JP)

(21) Appl. No.: 13/812,024

(22) PCT Filed: Nov. 22, 2010
(86) PCT No.: PCT/JP2010/070775

§ 371 Date: Jan. 24, 2013

(30) Foreign Application Priority Data
Sep. 21, 2010 (JP) 2010-210834

(51) Int. Cl. G06Q 30/06

(52) U.S. Cl. CPC G06Q 30/0627
USPC 705/26.63

(57) ABSTRACT

In a B-to B transaction performed via a telecommunication network, a supplier can obtain the opportunity of having a new business customer while a buyer can figure out a reasonable price of an item to be purchased, thereby reducing useless sourcing cost. Information indicative of items each buyer purchased in the past is stored correlated with each buyer in a purchase assistance device, which assists each buyer in purchases of items via electronic business transaction from any one of a plurality of suppliers, the items having a specification desired by each buyer. Further, information on similar items having the same specification is stored in the purchase assistance device correlated with the items that each buyer purchased. In response to a question about items a buyer purchased in the past, the information on similar items is presented to the buyer in the purchase assistance device, together with the information about the item.

### TECHNICAL FIELD

The present invention relates to a technology of assisting electronic business transactions performed via a telecommunication network such as the Internet, and particularly relates to a technology of assisting business transactions between businesses (B to B).

### BACKGROUND ART

An example of such a form of electronic business transaction is a purchase assistance system assisting the purchase of items or services (hereinafter may be abbreviated to items or the like) in businesses and the like. With such a type of purchase assistance system, many items or services registered in advance are categorized for each category or for each supply source (hereinafter, the supplier) of the items or the like, and are displayed as a list. The purchasing manager of a business on the purchasing side of the items or the like (hereinafter, the buyer) selects and orders items or the like with the desired specification (item specifications such as the raw materials, quality, uses, and functions in the case of items, service specifications such as quality and benefits in the case of services) out of the items or the like displayed as a list.

Patent Document 1: Japanese Unexamined Patent Application Publication No. 2005-309682

### DISCLOSURE OF INVENTION

### Problems to be Solved by the Invention

In business transactions between businesses, specifications for the delivery of an item or the like are generally different for each buyer depending on the transaction amount, the scale of the buyer business that is the buyer of an item or the like, the reliability of the buyer, and the like. In such a manner, the fact that the specification for the delivery of an item or the like is generally different for each buyer distinguishes business transactions between businesses with business transactions aimed at individuals. Here, the specifications for the delivery of an item or the like refer to the unit price, the delivery date, which is the period from receiving an order for an item or the like to the date of delivery, the delivery location, the delivery method, and the like of the item or the like. However, with the purchase assistance system of the related art in which desired items are selected by the user from items or the like displayed as a list, delivery specifications that differ for each buyer are not presented. Therefore, with the purchase assistance system of the related art, it is difficult for each buyer to figure out a reasonable unit price according to its own business scale and reliability in advance, and as a result, there is a possibility that an item or the like is purchased at a higher price than a reasonable unit price. That is, there is a possibility that a buyer is paying for useless sourcing costs. Further, from the position of the supplier, with the purchase assistance system of the related art, there was also the problem that there is little opportunity to obtain new business customers. This is because with the purchase assistance system of the related art, it is not possible to perform rational trading activities such as promoting the sale of a supplier's own item by presenting a unit price that reflects the business valuation seen from the supplier side to a specific buyer that has purchased an item or the like having the same or similar specification to the supplier's own item or the like in the past.

The present invention is made in view of the problems described above, and an object thereof is to provide a technology, in business transactions between businesses, allowing a supplier to obtain the opportunity of having a new business customer while a buyer can figure out a reasonable price of an item or the like to be purchased, thereby reducing useless sourcing cost.

### Means for Solving the Problems

In order to solve the problems described above, the present invention provides a purchase assistance method, wherein a purchase assistance device, being able to perform communication via a communication network with a plurality of supplier terminals that a plurality of suppliers providing items or services use and able to perform communication via a communication network with one or a plurality of buyer terminals that one or a plurality of buyers wishing to purchase an item or a service use, stores first information indicating the item specification of each item or the service specification of each service supplied by each of the plurality of suppliers, and stores second information indicating to the buyer the delivery specification including at least the unit delivery price for the buyer of the item or the service for each item or each service that each of the plurality of buyers purchases, wherein according to an access from the buyer terminal of one buyer, the purchase assistance device executes: a first step of presenting the items or services provided by each of the plurality of suppliers via the buyer terminal of the buyer and prompting selection of an item or a service; and a second step of presenting, via the buyer terminal of the buyer, as an item or a service is selected by the buyer in the first step, the first information indicating the item specification of the item selected by the buyer or the service specification of the service selected by the buyer and the second information indicating the delivery specification when delivering the item or the service selected by the buyer to the buyer, and presenting, via the buyer terminal of the buyer, the first information indicating the item specification or the service specification of a similar item or a similar service which is an item or a service other than the item or the service selected by the buyer, and has the same or similar item specification or service specification as the item or the service selected by the buyer and the second information indicating the delivery specification in a case where the similar item or the similar service is delivered to the buyer.

According to the method, when a buyer selects any item or service, in addition to the first and second information for the item or the service, the first and second information for similar items having the same or similar item specification as the item or similar services having the same or similar service specification as the service is presented to the buyer. Therefore, if each supplier registers information indicating the delivery specifications reflecting the business valuation of one or each of a plurality of buyers as the second information in a purchase assistance device, each supplier can promote the sale of a supplier's own item or the like to each buyer by presenting a delivery specification reflecting the business valuation of the buyer seen from the supplier side. At least information relating to the delivery unit price is included in the delivery specification so that a buyer can figure out a reasonable price for the purchase target item or the like, thereby realizing a reduction in useless sourcing cost. Further, by presenting the items or the like purchased by each user in the past on the purchase assistance device in the first step, each buyer can compare the delivery specifications of the items or the like purchased in the past with the delivery specifications of similar items or the like. Furthermore, if a delivery specification is advantageous to the buyer such as, for example, the unit price of a similar item or the like being cheaper, the buyer can reduce the sourcing cost by switching the item or the like to be purchased next time to the similar item or the like. Further, by browsing the delivery specification of a similar item or a similar service presented as described above, each buyer can figure out a reasonable unit price for the purchase target item by taking into account of the buyer's own business scale and the like.

A technology of revising disparities between buyers in a joint purchasing type reverse auction by individually determining the delivery unit price of each buyer from the successful bid price with respect to the total price according to the amount of purchase, the business scale, and the like of each buyer is disclosed in Patent Document 1. A problem to be solved in the technology disclosed in Patent Document 1 is to allocate the discount effect of joining purchasing fairly to each buyer participating in the joint purchasing type reverse auction. Therefore, the technology disclosed in Patent Document 1 is a different technology from the invention of the present application, in which an object is for the buyer to be able to figure out a reasonable price of an item or the like taking into account of the business scale and the like.

### BRIEF DESCRIPTION OF DRAWINGS

FIG. 1 is a view illustrating a configuration example of a purchase assistance system of a First Example of the present invention and a purchase assistance device 30 included in the system.

FIG. 2 is a view illustrating an example of the table format of a buyer information table stored in a nonvolatile memory unit 342 of a purchase assistance device 30.

FIG. 3 is a view illustrating an example of the table format of a supplier information table stored in the nonvolatile memory unit 342.

FIG. 4 is a view illustrating an example of the table format of an item information table stored in the nonvolatile memory unit 342.

FIG. 5 is a view illustrating an example of the table format of a transaction history table stored in the nonvolatile memory unit 342.

FIG. 6 is a view illustrating an example of the table format of a similar item information table stored in the nonvolatile memory unit 342.

FIG. 7 is a view illustrating an example of a communication sequence in a purchase assistance system.

FIG. 8 is a view illustrating an example of the format of each screen displayed on a supplier terminal 20C display unit and an example of the screen transition between each screen.

FIG. 9 is a view illustrating an example of the format of each screen displayed on the display unit of a buyer terminal 10 and an example of the screen transition between each screen.

FIG. 10 is a view for describing the effect of the present example.

### BEST MODES FOR CARRYING OUT THE INVENTION

Examples of the present invention will be described below with reference to the drawings.

### EXAMPLE 1

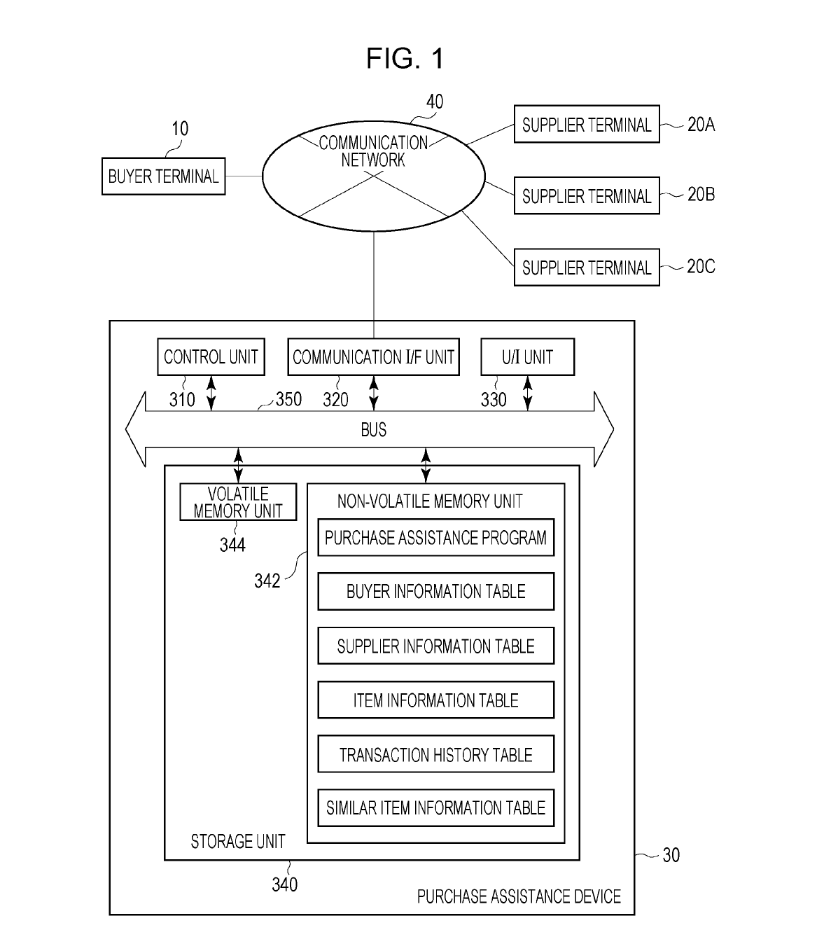

FIG. 1 is a view illustrating a configuration example of a purchase assistance system realizing the purchase assistance method of a first example of the present invention and a purchase assistance device 30 fulfilling a central function in the system. As illustrated in FIG. 1, the purchase assistance system is configured by each of a buyer terminal 10, supplier terminals 20A to 20C, and the purchase assistance device 30 being connected to a communication network 40 that is a telecommunication network such as the Internet. While only one buyer terminal is shown in FIG. 1, naturally, there may be two or more (that is, a plurality of) buyer terminals included in the purchase assistance system. The same is also true of supplier terminals. That is, the number of supplier terminals included in the purchase assistance system may naturally be two or less, and may be four or more.

The buyer terminal 10 of FIG. 1 is, for example, a personal computer. The buyer terminal 10 is a terminal device that the purchasing manager operates for a buyer X as the buyer of an item or a service. Each of the supplier terminals 20A, 20B, and 20C of FIG. 1 is also a personal computer. Each of the supplier terminals 20A, 20B, and 20C is a terminal device that the operations manager operates for each of a supplier A, supplier B, and supplier C as the sellers of an item. Here, in a case where there is no need to distinguish between each of the supplier terminals 20A, 20B, and 20C below, the supplier terminals will be referred to as a “supplier terminal 20”.

In the present example, a supplier A, a supplier B, and a supplier C are respectively selling items a1 to aN (N is a natural number), items b1 to bM (M is a natural number), and items c1 to cK (K is a natural number). Out of the items that the suppliers A to C sell, the item a1, the item b2, and the item c3 belong to the same item category and have the same item specification. On the other hand, the buyer X regularly purchases items using the purchase assistance system illustrated in FIG. 1. The item specification of an item that the buyer X is attempting to purchase using the purchase assistance system 1 matches the item specifications of the items a1, b2, and c3. That is, the items a1, b2, and c3 can become competitive items with each other in the purchasing of an item by the buyer X using the purchase assistance system. In the present example, each of the suppliers A to C and the buyer X has concluded the usage contract of the purchase assistance system illustrated in FIG. 1 with the application operator of the purchase assistance device 30, and each of the suppliers A to C and the buyer X further has concluded the following contract with the application operator. That is, each of the suppliers A to C and the buyer X signs a contract with the application operator to agree for others to reference the content of business transactions completed via the purchase assistance device 30. The reason for such a contract being concluded will be made clear later.

The buyer terminal 10 performs data communication based on HTTP or the like with the purchase assistance device 30 via the communication network 40. The buyer terminal 10 displays various screens for assisting the purchase of an item under the control of the purchase assistance device 30 on a display unit (not shown). Examples of screens that the buyer terminal 10 displays on the display unit include an item search screen, a screen displaying the result of an item search as a list, a purchased items list screen, an item details screen, and the like. An item search screen is a screen prompting the search of a purchasing target item to the purchasing manager of the buyer X. A specific example of the item search screen is an input screen for causing the purchasing manager to input information indicating the item specification of an item for which a purchase is desired and the delivery specification thereof. The purchased items list screen is a screen for causing the purchasing manager to verify the purchased items by displaying the item information of purchased items as a list. Furthermore, the item details screen is a screen for causing detailed information on a purchased item such as the item specification and the delivery specification to be verified by the purchasing manager.

Similarly to the buyer terminal 10 described above, the supplier terminal 20 performs data communication based on HTTP or the like with the purchase assistance device 30 via the communication network 40. The supplier terminal 20 causes various screens for assisting the sale of a supplier's own items to be displayed on a display unit (not shown) via the purchase assistance device 30 under the control of the purchase assistance device 30. Examples of screens that the supplier terminal 20 displays on the display unit include an item specification input screen, a buyer search screen, and a similar item registration screen. The item specification input screen is an input screen for causing the operations manager of each supplier to input information or the like representing the item specification or the delivery specification of a supplier's own item. The buyer search screen is a screen for causing the operations manager to search for buyers that have purchased items that are similar to a supplier's own item. In the present embodiment, an item that is similar to a supplier's own item is an item of another business having the same item specification as a supplier's own item. Furthermore, the similar item registration screen is an input screen for registering a supplier's own item as a similar item to a purchase item of a buyer that has purchased an item that is similar to the supplier's own item.

The purchase assistance device 30 is, for example, a personal computer. As illustrated in FIG. 1, the purchase assistance device 30 includes a control unit 310, a communication interface (hereinafter referred to as “I/F”) unit 320, a user interface (hereinafter referred to as “U/I”) unit 330, a memory unit 340, and a bus 350 mediating data transfer between the constituent elements. The control unit 310 is, for example, a CPU (Central Processing Unit). The control unit 310 functions as a control center of the purchase assistance device 30 by executing various programs stored on the memory unit 340. The communication I/F unit 320 is, for example, an NIC (Network Interface Card). The communication I/F unit 320 is connected to the communication network 40 via a relay device (not shown) such as a router. The communication I/F unit 320 receives communication messages and the like transmitted to the purchase assistance device 30 via the communication network 40 and delivers the communication message and the like to the control unit 310 while sending out the communication messages and the like delivered from the control unit 310 to the communication network 40. Here, an example of the communication message described above includes a communication message transceived according to HTTP. The U/I unit 330 includes a display unit (not shown) such as a liquid crystal display and an operation unit (not shown) such as a keyboard. The U/I unit 330 is for providing various user interfaces for performing the operations management and maintenance of the purchase assistance device 30.

The storage unit 340 includes a nonvolatile memory unit 342 and a volatile memory unit 344. The volatile memory unit 344 is, for example, a RAM (Random Access Memory). The volatile memory unit 344 is used as a work area when various programs are executed by the control unit 310. On the other hand, the nonvolatile memory unit 342 is, for example, a hard disk. A purchase assistant program and a database memorizing various pieces of data input by the buyer X and the suppliers A to C are stored in the nonvolatile memory unit 342. Here, the purchase assistance program is a program causing the control unit 310 to execute a process of supporting the purchase of an item by the buyer X or a promotion of the sale of an item by each supplier.

In order to avoid repetition, details of the process that the control unit 310 executes according to the purchase assistance program will be made clear in the description of the operation example of the present example. Here, the outline of the process that the control unit 310 executes according to the purchase assistance program will be described. First, the control unit 310 executes a process of turning the various pieces of information transmitted from the buyer terminal 10 and each of the supplier terminals 20A to 20C via the communication network 40 into a database and storing the information. Examples of the information to be turned into a database include business information representing the business content of the buyer and each supplier, information indicating the item specifications and the delivery specifications of items that each supplier sells, and the like. Further, the control unit 310 also executes a process of prompting the input of various pieces of data to be turned into the database to the manager of a buyer or a supplier. Furthermore, secondly, the control unit 310 executes a process of searching the storage content of the database described above according to a request from the buyer terminal 10 or the supplier terminal 20 and presenting the search result. For example, in a case where information indicating the item specification of an item that the buyer X wishes to purchase is received from the buyer terminal 10, the control unit 310 executes the following process. That is, the control unit 310 executes a process of searching the database described above and generating a list of corresponding items, and returning the list to the buyer terminal 10.

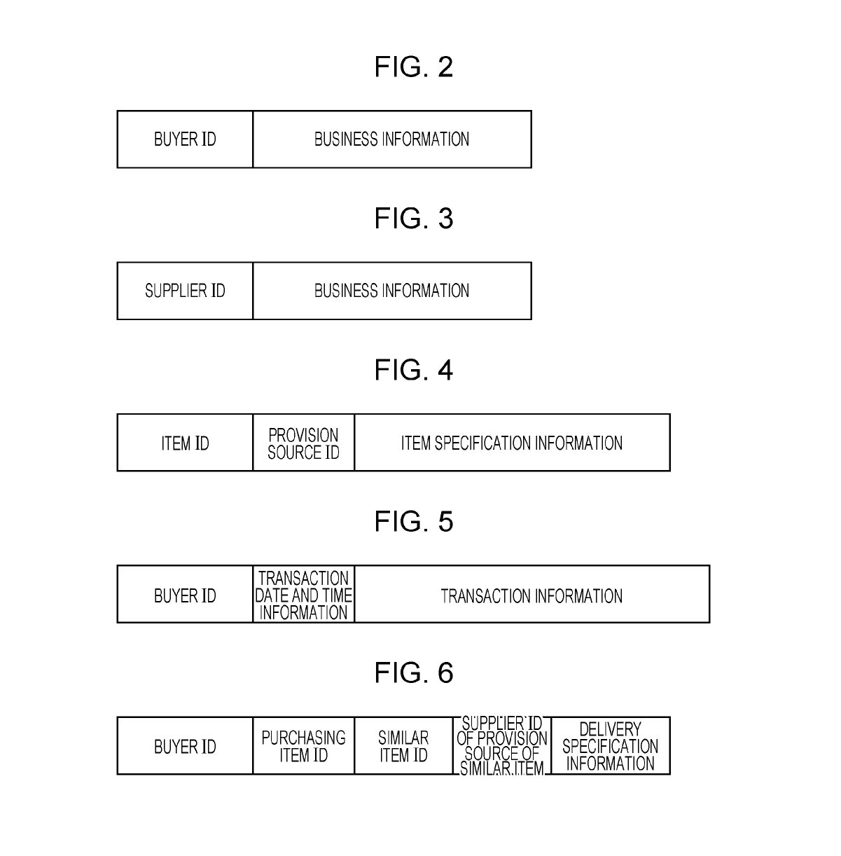

A buyer information table, a supplier information table, an item information table, a transaction history table, and a similar item information table are included in the database stored in the nonvolatile memory unit 342. FIGS. 2 to 6 are views illustrating examples of the table format of each table illustrated in FIG. 1. An example of the table format of a buyer information table is shown in FIG. 2. As illustrated in FIG. 2, business information, correlated with a buyer ID that is an identifier uniquely indicating each buyer, relating to the buyer identified by the buyer ID is registered on the buyer information table. A serial number, for example, may be used as the buyer ID. Various pieces of information necessary when performing a business transaction between businesses such as, for example, the business name, business type, location, capital, earnings, manager name, contacts, and the like are included in the business information. The registration of the buyer ID and the business information on the buyer information table is performed by a manager on the buyer side during user registration on the purchase assistance system illustrated in FIG. 1. The storage content of the buyer information table is used in user authentication or the like when each buyer logs into the purchase assistance system.

An example of the table format of the supplier information table is shown in FIG. 3. As illustrated in FIG. 3, business information, correlated with a supplier ID that is an identifier uniquely indicating each supplier, relating to the supplier identified by the supplier ID is registered on the supplier information table. A series of numbers or the like may also be used as the supplier ID. Similarly to the registration of various pieces of information on the buyer information table, registration of various pieces of information on the supplier information table is performed by a manager on the supplier side during user registration on the purchase assistance system. The storage content of the supplier information table is used in user authentication or the like when each supplier logs into the purchase assistance system.

An example of the table format of the item information table is shown in FIG. 4. As illustrated in FIG. 4, a provision source ID and item specification information are registered on the item information table correlated with an item ID that is an identifier uniquely indicating an item of each supplier. The model number of each item may be used as the item ID. The provision source ID is the supplier ID of the provision source of an item identified by the item ID. Furthermore, the item specification information is information indicating the item specification of an item identified by the item ID. The registration of various pieces of information on the item information table is performed by a manager on the supplier side at the time of user registration, starting the sale of a new item, or the like.

An example of the table format of the transaction history table is shown in FIG. 5. As illustrated in FIG. 5, transaction information, correlated with the buyer ID of a buyer that has purchased an item via the purchase assistance device 30 and transaction time and date information indicating the time and date of the transaction performed by the buyer, representing the content of the transaction is stored in the transaction history table. The item ID of the item that a buyer identified by a buyer ID correlated with the transaction information has purchased, the supplier ID of the provision source of the item, and the delivery specification information indicating the delivery specification thereof are included in the transaction history. In the present example, the combination of the buyer ID and the transaction time and date information fulfills the function of a transaction identifier uniquely identifying each transaction. A series of numbers or the like may be used as the transaction identifier in a case where each buyer performs a plurality of transactions on the same day, and the buyer ID and the transaction time and date information may be included in the transaction information.

A similar item ID, the supplier ID of the provision source of the similar item, and the delivery specification information of the similar item are registered on the similar item information table of FIG. 6 correlated with the buyer ID of a buyer that has purchased any item via the purchase assistance device 30 and a purchase item ID. The purchase item ID is the item ID of an item that a buyer indicated by a buyer ID correlated with the purchase item ID has purchased using the present purchase assistance system. The similar item ID is the item ID of another item having the same item specification as the item that the purchase item ID indicates, that is, of a similar item. Furthermore, the delivery specification information is information indicating the delivery specification in a case where the item that the similar item ID indicates is delivered to the buyer that the buyer ID indicates. The item ID of a similar item and the delivery specification information indicating the delivery specification thereof, correlated with a pair of buyer ID and purchase item ID, is registered to be compatible with customary practices in business transactions between businesses. As described above, this is because in business transactions between businesses, different delivery specifications are generally presented even for the same item according to the reliability of the buyer at the delivery destination, the purchase number and amount, and the like.

The first characteristic of the present example is to assist the sale of an item by the operations manager of a supplier. In the present example, the operations manager of a supplier registers information relating to the supplier's own item (the item specification and delivery specification, and the business information of the provision source) as information relating to a similar item, correlated with a buyer that has purchased an item in the past having the same item specification as the supplier's own item to be sold and the purchase item of the buyer, on the similar item information table. Furthermore, when the purchasing manager of the buyer browses information relating to an item purchased in the past, information relating to a similar item is presented along with information on the purchase item. In so doing, promoting the sale of a supplier's own item to a buyer that has purchased an item in the past having the same item specification as the supplier's own item to be sold is realized. Further, the buyer is able to compare the delivery specification of a purchase item with the delivery specifications of a similar item. The buyer being able to compare the delivery specification of the purchase item and the delivery specifications of a similar item is the second characteristic of the present example.

The above is the configuration of the purchase assistance device 30.

Next, the operation of each device in the present example will be described with a case where the supplier C newly performs user registration and promotes the sale of the item c3 to the buyer X as an example. Here, in the operation example described below, the buyer X, the supplier A, and the supplier B have been user registered on the purchase assistance system 1, and the buyer X has purchased the item a1 from the supplier A through an electronic business transaction via the purchase assistance device 30.

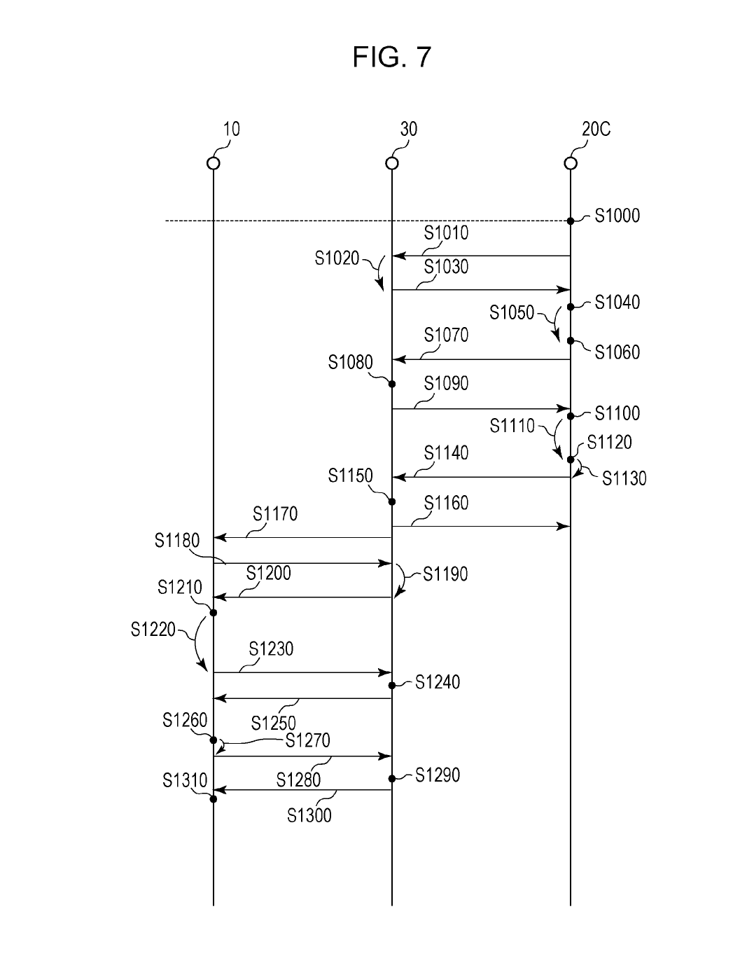

FIG. 7 is a view illustrating an example of a communication sequence illustrating the flow of communication that each device executes in the purchase assistance system of the present example. The operations manager of the supplier C who has completed the user registration of the supplier C (FIG. 7: S1000) and completed the registration of various pieces of information relating to the items c1 to cK on the item information table operates the operation unit (not shown) of the supplier terminal 20C and instructs login to the purchase assistance system (S1010). Specifically, the operations manager of the supplier C first causes the supplier terminal 20C to execute browser software. Next, the operations manager of the supplier C inputs an IP address (or a URL) assigned to the purchase assistance device 30 as a communication address indicating the login destination, and has user authentication from the purchase assistance device 30. As illustrated in FIG. 7, when the user authentication described above is successful (S1020), the control unit 310 of the purchase assistance device 30 returns HTML data representing a menu screen for the supplier (hereinafter, supplier menu screen) to the supplier terminal 20C (S1030). When the supplier terminal 20C receives the HTML data, the supplier terminal 20C causes a supplier menu screen to be displayed on a display unit (not shown) according to the HTML data (S1040).

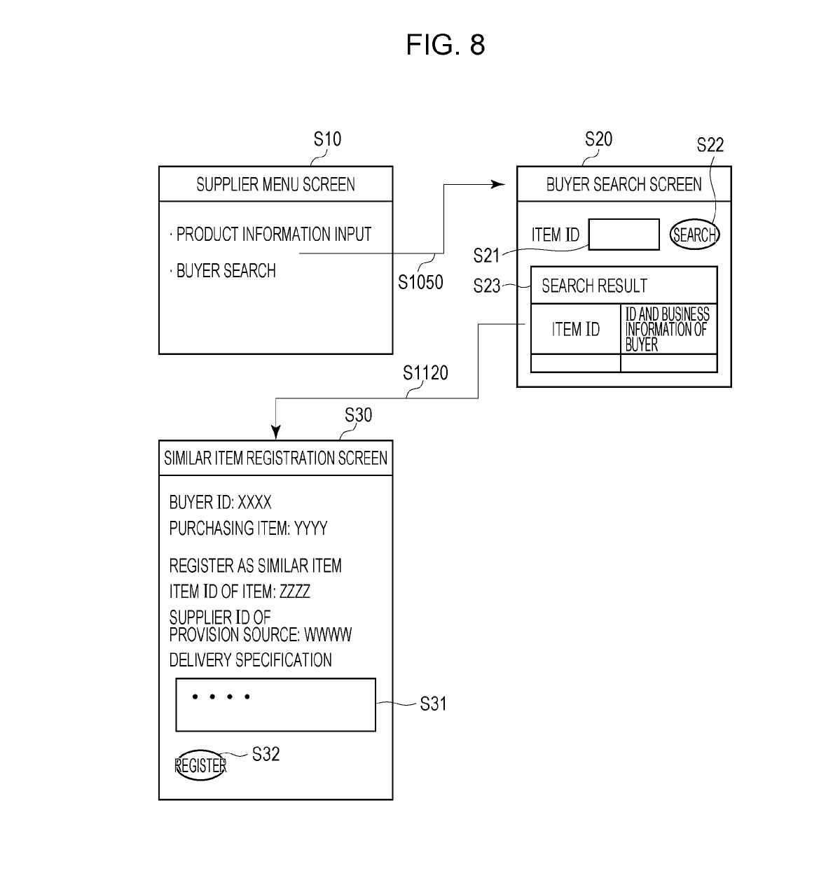

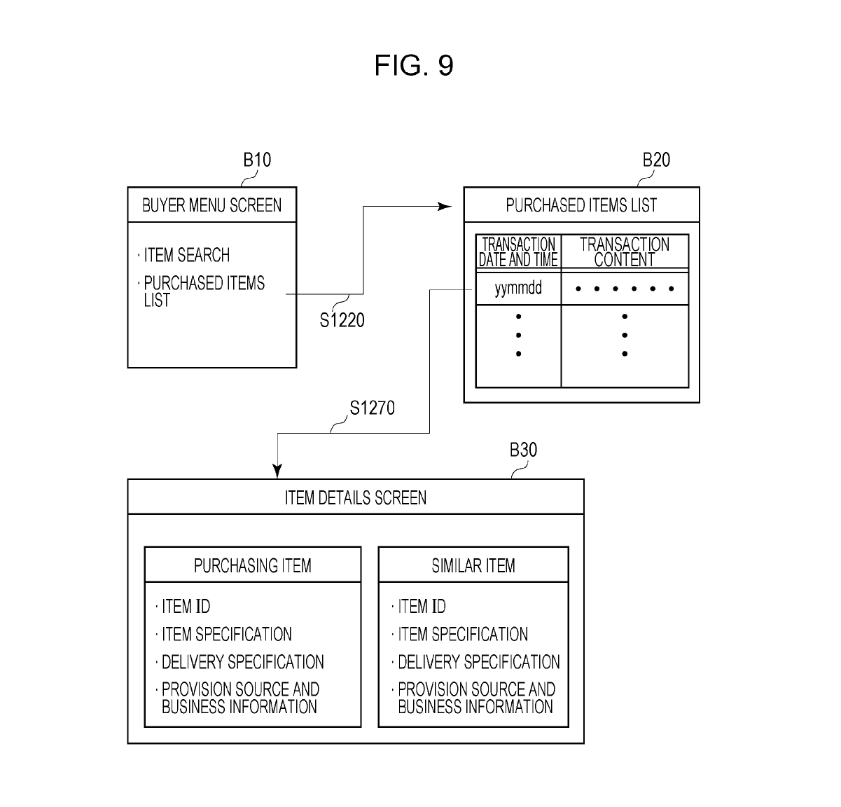

FIG. 8 is a view illustrating an example of the screen formats of a supplier menu screen S10, a buyer search screen S20, and a similar item registration screen S30 displayed on the display unit of the supplier terminal 20C and the screen transition between each screen. As illustrated in FIG. 8, a tag prompting the use of a service for a supplier provided by the purchase assistance device 30 is included in the supplier menu screen S10. In the present example, a service for a supplier is the input of item information and a buyer search. On the supplier menu screen S10, if the operations manager of the supplier C selects a “buyer search tag” through a mouse click or the like (FIGS. 7 and 8: S1050), the supplier terminal 20C notifies the purchase assistance device 30 of the fact. Furthermore, the supplier terminal 20 causes the buyer search screen S20 to be displayed on the display unit according to the HTML data returned from the purchase assistance device 30 (FIG. 7: S1060). In the sequence view of FIG. 7, the sequence of the data communication performed between the supplier terminal 20C and the purchase assistance device 30 for the display of the buyer search screen S20 is omitted. This is because the sequence of the data communication for the display of the buyer search screen S20 bears little relation to the present invention.

The buyer search screen S20 illustrated in FIG. 8 is a screen for causing each supplier to search for buyers that have purchased other items in the past having the same item specifications as the supplier's own item to be sold. Since each supplier can perform such a search, the conclusion of the contract described above (the contract agreeing to others referencing the content of a business transaction completed via the purchase assistance device 30) is necessary. When the buyer search screen S20 is displayed on the display unit of the supplier terminal 20C, the operations manager of the supplier C inputs the item ID of an item to be promoted for sales (the item c3 in the present operation example) into an input field S21 using a keyboard or the like, and mouse clicks a search button S22. The supplier terminal 20C then generates a search request message requesting a search of buyers that have purchased other items having the same item specifications as the item indicated by the item ID input into the input field S21, and transmits the search request message to the purchase assistance device 30 via the communication network 40 (FIG. 7: S1070).

The control unit 310 receiving the search request message performs a search of corresponding buyers on the following points (FIG. 7: S1080). First, the control unit 310 searches the item information table with the item ID included in the search request message as the search key, and obtains the item specification information correlated with the item ID (step SA01). Next, the control unit 310 searches the item information table with the item specification information obtained in step SA01 as the search key, and obtains the corresponding item ID (step SA02). To describe in more detail, the control unit 310 obtains an item ID correlated with the item specification information representing the same item specification and which is a different item ID to that included in the search request message (Step SA02). Next, the control unit 310 searches the transaction history table with the item ID obtained in step SA02 as the search key, and obtains a buyer ID registered on the transaction history table correlated with the transaction information including the item ID (step SA03). Next, the control unit 310 searches the buyer information table with the buyer ID as the search key and obtains the business information corresponding to the buyer ID. Furthermore, the control unit 310 returns the item ID obtained in step S02, the buyer ID obtained in step SA03 by a search with the item ID as the search key, and the business information obtained through a search with the buyer ID as the search key as the search results to the supplier terminal 20C (FIG. 7: S1090).

When the search result of the buyer search as described above is returned from the purchase assistance device 30, the supplier terminal 200 causes the search result to be displayed on a search result display field S23 of the buyer search screen S20 (FIG. 7: S1100). As described above, in the present example, the item c3 sold by the supplier C has the same item specifications as the item a1 sold by the supplier A and the item b2 sold by the supplier B. Therefore, in step SA02 described above, the item IDs of the item a1 and the item b2 are obtained. Furthermore, before the supplier C is user registered, since there has been a transaction involving the item a1 between the buyer X and the supplier A, a buyer ID (that is, the buyer ID of the buyer X) is obtained in step SA03 described above only in a case where the item ID of the item a1 is the search key. As a result, in the present example, the item ID of the item a1, the buyer ID of the buyer X, and the business information of the buyer X are displayed on the search result display field S23.

When the search result described above is displayed, the operations manager of the supplier C selects information relating to the item a1 included in the search result through a mouse click or the like (FIG. 7: S1110), and gives an instruction to perform registration of a similar item for the item a1. In the present operation example, the item ID of the item a1 and the buyer ID of the buyer X that is the purchaser of the item are selected as the information relating to the item a1 through a mouse click or the like. The supplier terminal 20C then notifies the purchase assistance device 30 that the registration of a similar item has been requested and causes the similar item registration screen S30 (refer to FIG. 8) to be displayed on the display unit according to the HTML data returned from the purchase assistance device 30 (FIG. 7: S1120). Here, the sequence of the data communication performed between the supplier terminal 20C and the purchase assistance device 30 for the display of the similar item registration screen is omitted in FIG. 7. As illustrated in FIG. 8, information selected by the mouse click described above, the item ID of the item to be registered as a similar item, and the supplier ID of the provision source of the similar item are displayed on the similar item registration screen S30. In the present operation example, the item ID of an item to be registered as a similar item is the item ID of the item c3, and the supplier ID of the provision source of the similar item is the supplier ID of the supplier C. Delivery specification information indicating the delivery specification in a case where a supplier's own item is sold to the buyer searched in the buyer search described above is input into the input field S31 of the similar item registration screen S30. The supplier C may freely determine the delivery specification by referring to the business scale, reliability, and the like of the buyer.

When the delivery specification is input into the input field S31 and a register button S32 are mouse clicked by the operations manager of the supplier C (FIG. 7: S1130), the supplier terminal 20C generates a similar item registration request message to request the registration of the similar item, and transmits the message to the purchase assistance device 30 (FIG. 7: S1140). The item ID of an item corresponding the supplier's own item as the similar item, the buyer ID of a buyer that has purchased the item identified by the item ID, the item ID of the supplier's own item to be registered as the similar item, the supplier ID of the provision source of the similar item, and the delivery specification information of the similar item are included in the similar item registration request message. The following information is included in the similar item registration request message transmitted from the supplier terminal 20C to the purchase assistance device 30 in the present operation example. That is, the item ID of the item a1 is included as the item ID of the item in which the supplier's own item is correlated as the similar item. The buyer ID of the buyer X is included as the buyer ID described above. The item ID of the item c3 is included as the item ID of the supplier's own item to be registered as the similar item. The supplier ID if the supplier C is included as the supplier ID of the provision source of the similar item. Furthermore, information indicating the delivery specification is included as the delivery specification information of the similar item in a case where the item c3 is delivered to the buyer X. As illustrated in FIG. 7, when the control unit 310 of the purchase assistance device 30 receives the similar item registration request message S1140 via the communication I/F unit 320, the control unit 310 writes the various pieces of information included in the similar item registration request message into the similar item information table (S1150). Furthermore, when the registration of the various pieces of information into the similar item information table is complete, the control unit 310 returns a registration completion notification notifying of the completion to the transmission source of the similar item registration request message (FIG. 7: S1160). Further, the control unit 310 transmits a similar item registration notification to the purchasing manager of the buyer identified by the buyer ID included in the similar item registration request message (FIG. 7: S1170). The similar item registration notification is transmitted to notify that a similar item has been registered for an item that the buyer has purchased in the past, and includes the item IDs of items that the buyer has purchased in the past and that there have been registered as similar items (the item ID of the item a1 in the present example).

The operations manager of the supplier C is made aware that the registration of the similar item has been completed by receiving the registration completion notification described above. On the other hand, the purchasing manager of the buyer X is made aware that a similar item has been registered for the item a1 purchased in the past by receiving the similar item registration notification. The purchasing manager of the buyer X can be made aware of detailed information such as the item specification and the business information of the provision source of the similar item described above, the delivery specification of the similar item to the buyer business, and the like through the following points. The purchasing manager of the buyer X operates an operation unit (not shown) of the buyer terminal 10, instructs login to the purchase assistance system (FIG. 7: S1180), and has user authentication from the purchase assistance device 30. As illustrated in FIG. 7, when the user authentication described above is successful (S1190), the control unit 310 of the purchase assistance device 30 returns the HTML data representing a menu screen for a buyer (hereinafter, buyer menu screen) to the buyer terminal 10 (FIG. 7: S1200). When the buyer terminal 10 receives the HTML data, the buyer terminal 10 causes the buyer menu screen to be displayed on a display unit (not shown) according to the HTML data (S1210).

FIG. 9 is a view illustrating an example of the formats of a buyer menu screen B10, a purchased items list screen B20, and an item details screen B30 displayed on the display unit of the buyer terminal 10 and the screen transition between each screen. As illustrated in FIG. 9, a tag prompting the use of a service for a buyer provided by the purchase assistance device 30 is included in the buyer menu screen B10. As illustrated in FIG. 9, a service for a buyer in the present example is to search for an item by designating an item specification, and to cause a purchased items list to be browsed. In the buyer menu screen B10, when the purchasing manager of the buyer X selects a “purchased items list” tag through a mouse click or the like (FIG. 7: S1220), the buyer terminal 10C writes the buyer ID of the buyer X into a search request message requesting the search of purchased items and transmits the search request message to the purchase assistance device 30 (FIG. 7: S1230).

When the control unit 310 of the purchase assistance device 30 receives the search request message transmitted in S1230, the control unit 310 searches the transaction history table with the buyer ID included in the search request message as the search key (FIG. 7: S1240) and obtains the transaction time and date information and the transaction information corresponding to the buyer ID. Furthermore, the control unit 310 returns the transaction time and date information and the transaction information obtained by the points described above as the search result to the transmission source of the search request message described above (FIG. 7: S1250). The buyer terminal 10 receiving the search result causes the purchased items list screen to be displayed on the display unit according to the transaction time and date information and the transaction information included in the search result (FIG. 7: S1260).

As illustrated in FIG. 9, transaction information indicating the transaction time and date when the buyer X performed the business transaction via the purchase assistance device 30 and the transaction content thereof is displayed as a list on the purchased items list screen B20 in order from the most recent. The purchasing manager of the buyer X selects information relating to the item for which the registration of the similar item has been notified through the similar item registration notification from among the transaction information displayed as a list through a mouse click or the like as described above (FIG. 7: S1270), and instructs a detailed display.

When a detailed display is instructed through a mouse click or the like, the buyer terminal 10 generates a communication message to request the transmission of information relating to the item indicated by item ID for which a detailed display has been instructed and the similar item for the item (hereinafter, detailed information transmission request message), and transmits the detailed information transmission request message to the purchase assistance device 30 (FIG. 7: S1280). The item ID of the item for which a detailed display has been instructed, the supplier ID of the provision source of the item, and the buyer ID of the transmission source of the message are included in the detailed information transmission request message. In the present operation example, the item ID of the item for which a detailed display has been instructed is the item that the buyer X has actually purchased, that is, the item ID of the item a1. Furthermore, the supplier ID of the provision source of the item is the supplier ID of the supplier A, and the buyer ID of the transmission source of the detailed information transmission request message is the buyer ID of the buyer X. The control unit 310 of the purchase assistance device 30 receiving the detailed information transmission request message obtains information relating to the purchase item of the transmission source of the message and information relating to the similar item by performing a database search by the following points (FIG. 7: S1290), and notifies the buyer terminal 10 of both pieces of information as the search result (FIG. 7: S1300).

First, the control unit 310 obtains information relating to the item that the transmission source of the detailed information transmission request message has actually purchased by the following points. The control unit 310 searches the item information table with the item ID included in the detailed information transmission request message as the search key, and obtains the item specification information corresponding to the item ID as information representing the item specification of the purchase item. In the present operation example, the search of the item information table is performed with the item ID of the item a1 as the search key. Next, the control unit 310 searches the supplier information table with the supplier ID included in the message as the search key, and obtains the business information corresponding to the supplier ID as the business information of the provision source of the purchase item described above. In the present operation example, the search of the supplier information table is performed with the supplier ID of the supplier A as the search key.

Meanwhile, the control unit 310 obtains information relating to the similar item by the following points. First, the control unit 310 searches the similar item table with the buyer ID and the item ID included in the detailed information transmission request message as search keys (with the item ID as the purchase item ID), and obtains the similar item ID, the supplier ID of the provision source, and the delivery specification information corresponding to the buyer ID and the purchase item ID. Next, the control unit 310 searches the item information table with the similar item ID as the search key, and obtains the item specification information corresponding to the item ID as information representing the item specification of the similar item. Further, the control unit 310 searches the supplier information table with the supplier ID obtained through the points described above as the search key, and obtains the business information corresponding to the supplier ID as the business information of the provision source of the similar item.

As described above, in the present operation example, the item ID of the item c3 is stored as the similar item ID in the similar item information table correlated with the item ID of the item a1 and the buyer ID of the buyer X, and the supplier ID of the supplier C is stored as the supplier ID of the provision source thereof in the table. Therefore, in the present operation example, the control unit 310 obtains the following information as information relating to the similar item of the item that the buyer X has actually purchased (item a1). That is, the control unit 310 obtains the item ID of the item c3, the item specification information representing the item specification of the item c3, the business information of the supplier C as the business information of the provision source thereof, and the delivery specification information representing the delivery specification in a case where the item c3 is delivered to the buyer X as information relating to the similar item.

The control unit 310 notifies the transmission source of the detailed information transmission request message of the information relating to the purchase item (item a1) obtained by the points described above (the item specification information and the business information of the provision source) and the information relating to the similar item (item c3) (the item ID, the item specification information, the business information of the provision source, and the delivery specification information) as the search result.

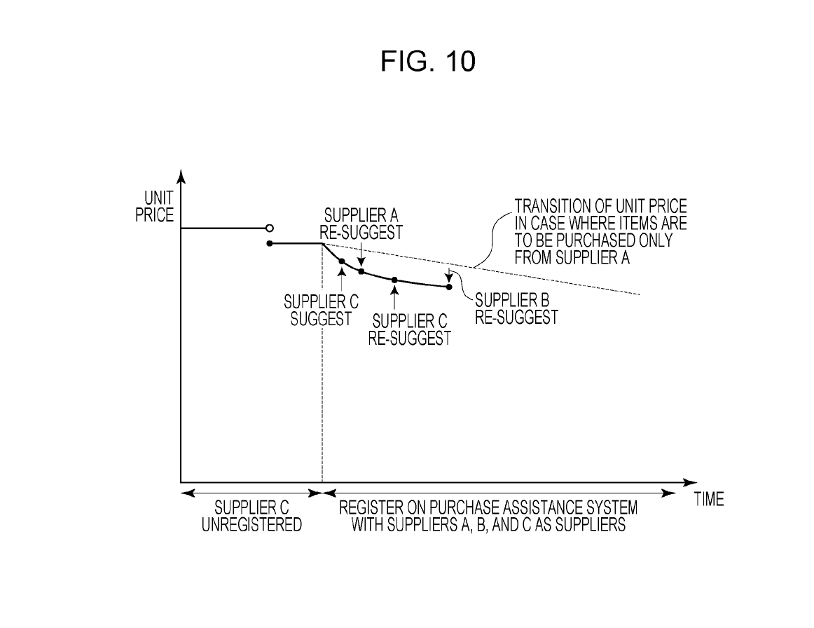

When the buyer terminal 10 receives the search result returned from the purchase assistance device 30, the buyer terminal 10 causes the item details screen B30 illustrated in FIG. 9 to be displayed on the display unit (FIG. 7: S1310). As illustrated in FIG. 9, information relating to the purchase item for which a detailed display has been instructed is inserted along with information relating to the similar item into the item details screen B30. In the present example, the item ID, the item specification, the delivery specification, and the business information of the provision source of the purchase item are inserted as the information relating to the purchase item into the item details screen B30. Here, the item ID and the delivery specification may be appropriated from those obtained when displaying the purchased items list. Meanwhile, the item ID, the item specification, the delivery specification, and the business information of the provision source of the similar item are inserted as the information relating to the similar item into the item details screen B30. The operations manager of the buyer X is able to compare the item specification and the delivery specification of the purchase item inserted into the item details screen B30 with the item specification and the delivery specification of the similar item, and if the delivery specification of the similar item is advantageous to the buyer X (for example, the unit price is cheaper or the like), the next purchasing target item may be switched to the similar item. In such a manner, by performing a switch of the purchasing target item, other supplies can be urged to reconsider the delivery specification such as price competition (refer to FIG. 10). Specifically, in a case where the buyer X switches the purchasing target item to the item c3, the supplier A is intended to register the item a1 as a similar item, and to register the new delivery specification. Here, attention is to be paid to the fact that the delivery specification that each supplier presents to the buyer X is determined based on the business scale, the reliability, and the like of the buyer X. Therefore, by each supplier repeating the reconsideration of the delivery specification with respect to the buyer X as illustrated in FIG. 10, the buyer X can figure out a reasonable item price taking its own business scale and reliability into consideration, optimizing the sourcing cost.

Meanwhile effects seen from the standpoint of the supplier include obtaining the opportunity of having new business customers. In operations activities of the related art, personal connections such as local ties, blood relations, and academic ties served an important role, and it could be said that the principle of objective and rational competition was not always in effect. However, in the present example, it is clear how each supplier evaluates the business value on the purchasing side of an item through the delivery specification that each supplier presents to the buyer. The buyer is able to select the transaction destination by responding to such evaluations. Therefore, it is hoped that the principle of objective and rational competition comes into effect, and that each supplier can have new business customers without regard for personal connections such as local ties. Further, from the standpoint of the supplier, while being forced into competition such as the reconsideration of delivery specifications, on the other hand, it is hoped that there is also the effect of determining, at an early point, the survival strategy (whether to compete on price, whether to distinguish items, or the like) for the supplier within the market by considering the sales (procurement) history and the like.

In such a manner, according to the present example, in electronic business transactions between businesses performed via a telecommunication network, the supplier obtains the opportunity to have new business customers, while the buyer can figure out a reasonable price of a purchasing target item, reducing useless sourcing cost.

While Example 1 of the present invention has been described above, as shown in Example 2 to Example 9 described below, Example 1 may be modified.

### EXAMPLE 2

In Example 1 described above, a case where the present invention is applied to the assistance of the purchasing of an item by the buyer X was described. However, the purchasing target by the buyer X is not limited to a tangible item, and naturally, may also be a service. Even an intangible service may be the target of a business transaction in the same manner, since a similar service can be conceived through the specification of a service such as the effect or the quality of a service. Further, while the present invention was applied to a purchase assistance system in Example 1 described above, naturally, the present invention may also be applied to a system of assisting the purchasing of an item through a reverse auction. For example, when a similar item is registered correlated with an item purchased by each buyer in reverse auctions held in the past, and the buyer attempts to browse the specification (the item specification and the delivery specification) of an item purchased in the past, information (the item specification and the delivery specification) of similar items corresponding to the item for which browsing was instructed may be presented.

### EXAMPLE 3

In Example 1 described above, the supplier obtains information relating to a buyer that has actually purchased an item having the same or similar item specification to the item that the supplier sells by the following points. That is, the supplier obtains information relating to a corresponding buyer by searching the item information table with the item ID of an item that the supplier sells as the search key, and searching the transaction information table with the item specification information stored in the item information table correlated with the item ID as the search key. However, the searching form for obtaining information relating to the buyer as the selling destination of an item that a supplier sells is not limited to the form described above. For example, a form of designating a certain supplier (hereinafter, target supplier) and searching for buyers that have purchased items from the target supplier can also be considered. Further, a form of searching for buyers that have purchased items from the supplier having a similar or the same item specification as a specific item (for example, an item that the supplier sells) can also be considered. This can be realized by causing the supplier to input the supplier ID of the target supplier during the buyer search, searching the transaction history table with the supplier ID of the target supplier as the search key, and obtaining a buyer ID stored in the transaction information table correlated with transaction information including information corresponding to the search key. Alternatively, the buyer ID stored in the transaction information table may be obtained by causing the supplier to input the supplier ID of the target supplier and the item IDs of items having the same or similar item specifications as the item that the supplier sells out of the items that the supplier sells, searching the transaction history table with the supplier ID and the item IDs as the search keys, and correlated the supplier ID and the item IDs with the transaction information including information corresponding to the search keys.

### EXAMPLE 4

While one similar item is correlated with one item in Example 1 described above, naturally, a plurality of similar items may be correlated with one item. Furthermore, in a case where a plurality of similar items are correlated with an item for which a detailed display has been instructed by the buyer, a process of sorting the information relating to each of the plurality of similar items using a fixed standard may be executed by the buyer terminal 10 or the purchase assistance device 30. Here, using the order in which similar items have been registered (for example, displaying the items registered most recently at the top of the list, or the like) or the like as the standard when sorting the information relating to each of the plurality of similar items can be considered. However, it is even more effective if the information relating to each of the plurality of similar items is sorted using values of entries, out of entries forming the delivery specifications of the similar items, that can conceive the difference with the delivery specification such as the unit price and the delivery time of the item for which the display of detailed information has been instructed by the buyer as a numerical value. Further, the information relating to each of the plurality of similar items may also be sorted using the difference between the similar items with the entries that can conceive the difference in the delivery specification as numerical values and the item for which the display of detailed information has been instructed by the buyer. This is because the buyer can clearly figure out the cost cutting effect, the shortening of the delivery time, and the like through such values of entries (or the difference in the entries). Further, so that the buyer can figure out the cost cutting effect, the shortening of the delivery time, and the like more clearly, the difference in delivery specifications may be displayed for entries that can be conceived as numerical values regardless of whether the number of similar items correlated with the item for which a detailed display has been instructed by the buyer is one or a plurality, and furthermore, the display color when the difference is displayed may be changed according to the extent of the difference. Here, in a case where there is a plurality of entries that can conceive the difference in the delivery specification with the item for which the display of detailed information has been instructed by the buyer in the entries configuring the delivery specifications of the similar items as a numerical value, what entry of the plurality of entries is used for performing the sorting described above (or whether to perform a display of differences) may be determined by each buyer in advance.

Further, sorting of the information relating to a similar item may be performed based on the evaluation provided by a buyer or a third-party purchasing consultant with regard to a delivery specification presented by a supplier in relation to a similar item. For example, an evaluation standard such as evaluation points of 10 points (−10 points) if the unit price is 5 percent lower (higher) compared to the item for which a detailed display has been instructed and evaluation points of 20 points (−20 points) if the unit price is 10 percent lower (higher) is determined for each entry configuring the delivery specification by the buyer or the purchasing consultant in advance. Furthermore, a process of calculating the evaluation points for each entry according to the evaluation standard and a process of sorting the information relating to the similar item in order of the most evaluation points are executed by the buyer terminal 10 (or the purchase assistance device 30), or the like. Through such a form, an overall comparison of the item with a similar item can be performed including entries that cannot conceive the difference with the item for which the display of detailed information has been instructed by the buyer as a numerical value (for example, the delivery method, the delivery location, and the like). Further, rather than determining the evaluation standard only for entries configuring the delivery specification, the evaluation standard may be determined in relation to the business information of the supplier, and the evaluation standard may be determined in relation to both the delivery specification and the business information of the supplier. For example, as an evaluation standard in relation to the business information, evaluation points of 10 points for capital of less than 10 million yen and evaluation points of 20 points for capital of equal to or greater than 10 million yen and less than 20 million yen can be considered. Further, if the evaluation standard described above is determined not by the buyer but by a purchasing consultant, it is hoped that a more objective evaluation can be made by reflecting the experience and the knowhow of the consultant in the evaluation standard described above. Further, similarly, in a case where information relating to a plurality of buyers is obtained through a buyer search, the evaluation standard may be determined by the supplier (or a purchasing consultant) for each entry configuring the business information of the buyers in advance. Furthermore, a process of calculating the evaluation points for each entry obtained according to the evaluation standard and a process of sorting the information relating to each of the plurality of buyers in order of the highest total of evaluation points are executed by the supplier terminal 20 (or the purchase assistance device 30).

### EXAMPLE 5

In Example 1 described above, the item specification and the delivery specification of a similar item having the same item specification of an item were presented when presenting the detailed specification of an item that the buyer X had purchased in the past via the purchase assistance device 30. However, naturally, the present invention may also be applied at the verification stage of the detailed specification of the item for which a purchase is desired. With a typical purchase assistance device, an item is often ordered (alternatively, a detailed specification is presented) by the identifiers of each item (the name, the serial number, and the like of an item) being categorized into each category of an item and displayed as a list, and selecting the desired identifier from the identifiers displayed as a list in such a manner through a mouse click or the like. Therefore, information indicating a similar item having the same item specification as an item corresponding to each item may be stored in a purchase assistance device for running the purchase assistance system described above, and a process of presenting information on the similar item along with the detailed specification of the item as the presentation of a detailed specification for any item is instructed through a mouse click or the like may be executed by the purchase assistance device.

### EXAMPLE 6

In Example 1 described above, a case where a different delivery specification is set for each buyer according to the business scale and the reliability of the buyer when each supplier sets the delivery specification of an item is described. However, the delivery specification may be set by talking the purchasing number and amount into consideration in addition to the business scale and the reliability (a delivery specification that is more advantageous to the purchasing side the greater the purchasing number and amount), and the delivery specification may also be set according only to the purchasing number and amount regardless of the business scale and reliability.

### EXAMPLE 7

In Example 1 described above, an item having the same item specification as a purchased item of the buyer X is registered as a similar item. However, an item having a similar item specification to a purchased item of the buyer X may also be included as a similar item with respect to the purchased item. Here, a similar item specification refers, for example, to an item specification in which a portion of a plurality of entries configuring the item specification being different such as a portion of the raw materials being different, where other entries match. Further, in addition to the item specifications being the same or similar, the buyer X may be made to designate the delivery specification, and having the same or similar delivery specification as the designated delivery specification may be made a requirement for a similar item. Here, a similar delivery specification is, for example, where a portion of a plurality of entries configuring the delivery specification differs while others match, such as a case where only the delivery location is different or a case where only the delivery method is different. Further, in a case where the same or similar delivery specification is made a requirement for a similar item in addition to the same or similar item specification, entries that cannot be compromised out of a plurality of entries configuring the delivery specification (the delivery time, the unit price, the delivery location, the delivery method, and the like) may be designated by the buyer in advance, and a complete match of entries designated by the buyer as not being able to be compromised may be made a requirement for a similar item.

### EXAMPLE 8

While correlating of a similar item is performed with the item specification being the same as a condition regardless of any differences in the provision source in Example 1 described above, correlating of a similar item may be permitted only in a case where the provision source is the same. For example, in a case where the item a1 that the supplier A sells and the items b1 and b2 that the supplier B provides have the same item specifications, while it is permitted to register the item b2 as a similar item with respect to the item b1, the item b1 (or the item b2) is prohibited from being registered as a similar item with respect to the item a1 (and vice versa). With such a form, since there is no longer a need to reference the transaction information relating to other suppliers when performing a search for buyers that have purchased an item to be correlated with the similar item, there is no longer a need for each supplier to conclude a contract to agree to the contents of business transactions completed via the purchase assistance device 30 being referenced by others.

### EXAMPLE 9

A purchase assistance program causing the control unit 310 to execute processes clearly exhibiting the characteristics of the present invention is stored in the nonvolatile memory unit 342 in advance in Example 1 described above. However, the program described above may be written into a computer-readable recording medium such as a CD-ROM (Compact Disk-Read Only Memory) and distributed, or the program described may be distributed by a download via a telecommunication network such as the Internet. This is so that by storing a database formed of each table illustrated in FIG. 2 in a general-use computer device and running the control unit (CPU) of the computer device according to a program distributed as described above, the computer device can be made to function as the purchase assistance device 30 of Example 1 described above.

### REFERENCE NUMERALS

10: buyer terminal, 20A, 20B, 20C: supplier terminal, 30: purchase assistance device, 310: control unit, 320: communication I/F unit, 330: U/I unit, 340: memory unit, 342: nonvolatile memory unit, 344: volatile memory unit, 350: bus

1-30. (canceled)

31. A purchase assistance method,
wherein a purchase assistance device, being able to perform communication with a plurality of supplier terminals that a plurality of suppliers providing items or services use via a communication network and able to perform communication with one or a plurality of buyer terminals that one or a plurality of buyers wishing to purchase an item or a service via a communication network use, stores first information indicating an item specification of each item or a service specification of each service supplied by each of the plurality of suppliers, and stores second information indicating a delivery specification including at least a unit delivery price for the buyer of an item or a service for each item or each service that each of the plurality of buyers purchases,
wherein according to an access from the buyer terminal of one buyer, the purchase assistance device executes:
a first step of presenting the items or services provided by each of the plurality of suppliers via the buyer terminal of the buyer and prompting selection of an item or a service; and
a second step of presenting, via the buyer terminal of a buyer, as an item or a service is selected by the buyer in the first step, the first information indicating the item specification of the item selected by the buyer or the service specification of the service selected by the buyer and the second information indicating the delivery specification when delivering the item or the service selected by the buyer to the buyer, and presenting, via the buyer terminal of the buyer, the first information indicating the item specification or the service specification of a similar item or a similar service which is an item or a service other than the item or the service selected by the buyer, and has a same or similar item specification or service specification as the item or the service selected by the buyer and the second information indicating the delivery specification in a case where the similar item or the similar service is delivered to the buyer.

32. The purchase assistance method according to claim 31,
wherein the purchase assistance device stores third information correlating the items or services having the same or similar item specifications or service specifications as one another among the items or services provided by the plurality of suppliers, and the similar item or the similar service is selected in the second step by referring to the third information.

33. The purchase assistance method according to claim 32,
wherein the purchase assistance device has the same or similar delivery specification in addition to the same or similar item specification or service specification as a requirement of storing the third information.

34. The purchase assistance method according to claim 33,
wherein the delivery specification represents a unit price, a delivery date, a delivery location, and a delivery method of an item or a service.

35. The purchase assistance method according to claim 32,
wherein the purchase assistance device generates and stores the third information in accordance with a request from each of the plurality of supplier terminals.

36. The purchase assistance method according to claim 35,
wherein when the purchase assistance device generates and stores the third information correlating, for an item or a service with a certain buyer as a delivery destination, the similar items or similar services with the item or the service, the purchase assistance device notifies the buyer as the delivery destination of the item or the service correlated with the similar items or the similar services by the third information, of the generation and storage of the third information.

37. The purchase assistance method according to claim 35,
wherein the purchase assistance device stores transaction history information relating to an item or a service which each supplier supplies to the buyer correlating with the one or each of the plurality of buyers, and in a case where a search request including a specifying of a desired item or service is received from one of the plurality of supplier terminals, the purchase assistance device searches the transaction history information relating to other items having the same or similar item specification as the item specification of the item or other services having the same or similar service specification as the service specification of the service, and transmits information indicating the item or the service that the transaction history information as the search result indicates and the buyer as the delivery destination of the item or the service to the supplier terminal as a transmission source of the search request.

38. The purchase assistance method according to claim 37,
wherein the supplier receiving, as a response to the transmission of the search request, the information indicating the item or the service that the transaction history information as the search result indicates and the buyer as the delivery destination of the item or the service instructs desired items or services among items or services indicated by the received information to the purchase assistance device using the supplier terminal of the supplier, and
the purchase assistance device generates and stores the third information correlating the item or the service designated by the search request with the item or the service instructed by the supplier.

39. The purchase assistance method according to claim 38,
wherein the purchase assistance device generates and stores the third information with a condition that a supplier as a provision source of the item or the service designated by the search request is the same as the supplier as the provision source of the item or the service instructed by the supplier.

40. The purchase assistance method according to claim 31,
wherein in a case where there are a plurality of similar items or similar services for the item or the service selected in the first step, in the second step, the purchase assistance device sorts the second information for each of the plurality of similar items or similar services in accordance with a standard determined in advance, and presents the first and second information in a sorting order.

41. The purchase assistance method according to claim 31,
wherein in the second step, when presenting the first and second information for the item or the service selected in the first step and the first and second information for similar items or similar services to the item or the service, the purchase assistance device further presents a numerical value representing a difference in the delivery specifications of the item or the service and the similar items or the similar services for entries that can be represented by a numerical value out of a plurality of entries configuring the delivery specifications of the item or the service and the similar items or similar services.

42. The purchase assistance method according to claim 41,
wherein in the second step, when presenting a numerical value indicating the difference in the delivery specifications between the item or the service selected in the first step and the similar items or the similar services to the item or the service, the purchase assistance device presents the numerical value in a display color according to a size of the numerical value.

43. A purchase assistance device comprising:
a communication interface unit communicating with each buyer terminal of one or a plurality of buyers who purchase an item or a service via a communication network and communicating with each supplier terminal of one or a plurality of suppliers who are provision sources of each item or service via a communication network;
a database on which is stored first information indicating an item specification of an item or a service specification of a service for an item or a service provided by each of the plurality of suppliers and second information as a delivery specification in a case where the item or the service is delivered to each of the plurality of buyers, indicating a delivery specification including at least a unit delivery price; and
a control unit executing a first process of presenting the items or the services provided by each of the plurality of suppliers via the buyer terminal of a buyer and prompting selection of an item or a service, according to an access from a buyer terminal of any buyer among the one or the plurality of buyers, and a second process of causing, in a case where it is detected by communication via the communication interface unit that any item or service has been selected, first and second information to be displayed on the buyer terminal by returning the first and second information to the buyer terminal of the buyer by reading from the database the first information on the item or the service selected by the buyer and the second information indicating the delivery specification when delivering the selected item or the service to the buyer, and causing the first and second information for the similar item or the similar service to be displayed on the buyer terminal of the buyer by returning the first and second information to the buyer terminal of the buyer by reading from the database the first information indicating the item specification or the service specification of a similar item or a similar service which is an item or a service other than the item or the service selected by the buyer, and has a same or similar item specification or service specification as the item or the service selected by the buyer and the second information indicating the delivery specification in a case where the similar item or the similar service is delivered to the buyer.

44. The purchase assistance device according to claim 43,
wherein the database stores third information correlating the items or the services having the same or the similar item specifications or service specifications among items or services provided by the plurality of supplier with one another, and
the control unit selects the similar item or the similar service in the second process by referring to the third information.

45. The purchase assistance device according to claim 44,
wherein according to the third information stored on the database, items or services in which the item specifications or the service specifications are the same or similar and in which the delivery specifications are the same or similar are correlated with one another.

46. The purchase assistance device according to claim 45,
wherein the delivery specification represents a unit price, a delivery date, a delivery location, and a delivery method of an item or a service.

47. The purchase assistance device according to claim 44,
wherein the control unit generates the third information in accordance with a request from each of the plurality of supplier terminals and stores the generated third information on the database.

48. The purchase assistance device according to claim 47,
wherein when the control unit stores the third information correlating, for an item or a service with a certain buyer as a delivery destination, the similar items or similar services with the item or the service, on the database, the control unit notifies the buyer as the delivery destination of the item or the service correlated with the similar items or the similar services by the third information, of the generation and storage of the third information.

49. The purchase assistance device according to claim 47,
wherein the control unit stores transaction history information relating to an item or a service which each supplier supplies to the buyer correlating with the one or each of the plurality of buyers on the database, and in a case where a search request including a specifying of a desired item or service is received from one of the plurality of supplier terminals, the control unit searches the transaction history information relating to other items having the same or similar item specification as the item specification of the item or other services having the same or similar service specification as the service specification of the service, and transmits information indicating the item or the service that the transaction history information as the search result indicates and the buyer as the delivery destination of the item or the service to the supplier terminal as a transmission source of the search request.

50. The purchase assistance device according to claim 49,
wherein when the supplier receiving, as a response to the transmission of the search request, the information indicating the item or the service that the transaction history information as the search result indicates and the buyer as the delivery destination of the item or the service instructs desired items or services indicated by the received information using the supplier terminal of the supplier, the control unit generates and stores, on the database, the third information correlating the item or the service designated by the search request with the item or the service instructed by the supplier.

51. The purchase assistance device according to claim 50,
wherein the control unit generates and stores, on the database, the third information with a condition that a supplier as a provision source of the item or the service designated by the search request is the same as the supplier as the provision source of the item or the service instructed by the supplier.

52. The purchase assistance device according to claim 43,
wherein in a case where there are a plurality of similar items or similar services for the item or the service selected by the buyer who has been prompted to select an item or a service in the first process, in the second process, the control unit sorts the first and second information for each of the plurality of similar items or similar services in accordance with a standard determined in advance, and causes the first and second information to be displayed on the buyer terminal of the buyer in a sorting order.

53. The purchase assistance device according to claim 43,
wherein when displaying the first and second information for the item or the service selected by the buyer who has been prompted to select an item or a service in the first process and the first and second information for similar items or similar services to the item or the service on the buyer terminal of the buyer, the control unit further displays a numerical value representing a difference in the delivery specifications of the item or the service and the similar items or the similar services for entries that can be represented by a numerical value out of a plurality of entries configuring the delivery specifications of the item or the service and the similar items or similar services.

54. The purchase assistance device according to claim 53,
wherein when displaying a numerical value indicating the difference in the delivery specifications between the item or the service selected by the buyer who has been prompted to select an item or a service in the first process and the similar items or the similar services to the item or the service, the control unit displays the numerical value in a display color according to a size of the numerical value.

55. A purchase assistance system comprising:
buyer terminals that one or a plurality of buyers purchasing each item or service uses;
supplier terminals that one or a plurality of suppliers as a provision source of each item or service uses; and
a purchase assistance device communication with each buyer terminal of the one or a plurality of buyers via the communication network,
wherein the purchase assistance device stores first information indicating an item specification of an item or a service specification of a service for an item or a service provided by each of the plurality of suppliers and second information as a delivery specification in a case where the item or the service is delivered to each of the plurality of buyers, indicating a delivery specification including at least a unit delivery price,
wherein the purchase assistance device executes:
a first process of presenting the items or services provided by each of the plurality of suppliers via the buyer terminal of a buyer and prompting selection of an item or a service according to an access from a buyer terminal of any buyer among the one or the plurality of buyers and;
a second process of causing, according to any item or service being selected, first and second information to be displayed on the buyer terminal by returning to the buyer terminal of the buyer the first information on the item or a service selected by the buyer and the second information indicating the delivery specification when delivering the selected item or service to the buyer, and causing the first and second information for the similar item or the similar service to be displayed on the buyer terminal of the buyer by returning to the buyer terminal of the buyer the first information indicating the item specification or the service specification of a similar item or a similar service which is an item or a service other than the item or the service selected by the buyer, and has a same or similar item specification or service specification as the item or the service selected by the buyer and the second information indicating the delivery specification in a case where the similar item or the similar service is delivered to the buyer.

56. The purchase assistance system according to claim 55,
wherein the purchase assistance device stores third information correlating the items or the services having the same or similar item specifications or service specifications as one another among the items or the services provided by the plurality of suppliers, and the similar item or the similar service is selected in the second process by referring to the third information.

57. The purchase assistance system according to claim 56,
wherein according to the third information stored on the purchase assistance device, items or services in which the item specifications or the service specifications are the same or similar and in which the delivery specifications are the same or similar are correlated with one another.

58. The purchase assistance system according to claim 57,
wherein the delivery specification represents a unit price, a delivery date, a delivery location, and a delivery method of an item or a service.

59. The purchase assistance system according to claim 56,
wherein the purchase assistance device generates the third information in accordance with a request from each of the plurality of supplier terminals and stores the generated third information.

60. The purchase assistance system according to claim 59,
wherein when the purchase assistance device stores the third information correlating, for an item or a service with a certain buyer as a delivery destination, the similar items or similar services with the item or the service, the purchase assistance device notifies the buyer as the delivery destination of the item or the service correlated with the similar items or the similar services by the third information, of the generation and storage of the third information.

61. The purchase assistance system according to claim 59,
wherein the purchase assistance device stores transaction history information relating to an item or a service which each supplier supplies to the buyer correlating with the one or each of the plurality of buyers, and in a case where a search request including a specifying of a desired item or service is received from one of the plurality of supplier terminals, the purchase assistance device searches the transaction history information relating to other items having the same or similar item specification as the item specification of the item or other services having the same or similar service specification as the service specification of the service, and transmits information indicating the item or the service that the transaction history information as the search result indicates and the buyer as the delivery destination of the item or the service to the supplier terminal as a transmission source of the search request.

62. The purchase assistance system according to claim 61,
wherein when the supplier receiving, as a response to the transmission of the search request, the information indicating the item or the service that the transaction history information as the search result indicates and the buyer as the delivery destination of the item or the service instructs desired items or services among items or services indicated by the received information using the supplier terminal of the supplier, the purchase assistance device generates and stores the third information correlating the item or the service designated by the search request with the item or the service instructed by the supplier.

63. The purchase assistance system according to claim 62,
wherein the purchase assistance device generates and stores the third information with a condition that a supplier as a provision source of the item or the service designated by the search request is the same as the supplier as the provision source of the item or the service instructed by the supplier.

64. The purchase assistance system according to claim 55,
wherein in a case where there are a plurality of similar items or similar services for the item or the service selected by the buyer who has been profited to select an item or a service in the first process, in the second process, the purchase assistance device sorts the first and second information for each of the plurality of similar items or similar services in accordance with a standard determined in advance, and presents the first and second information in a sorting order.

65. The purchase assistance system according to claim 55,
wherein when displaying the first and second information for the item or the service selected by the buyer who has been profited to select an item or a service in the first process and the first and second information for similar items or similar services to the item or the service on the buyer terminal of the buyer, the purchase assistance device further displays a numerical value representing a difference in the delivery specifications of the item or the service and the similar items or similar services for entries in which the difference can be represented by a numerical value out of a plurality of entries configuring the delivery specifications of the item or the service and the similar items or similar services.

66. The purchase assistance system according to claim 55,
wherein when displaying a numerical value indicating the difference in the delivery specifications between the item or the service selected by the buyer who has been profited to select an item or a service in the first process and similar items or similar services to the item or the service, the purchase assistance device displays the numerical value in a display color according to a size of the numerical value.
